(19) United States
(12) Patent Application Publication
(10) Pub. No.: US 2024/0390990 A1
(43) Pub. Date: Nov. 28, 2024

(54) OFFSET COLLET LOCK FOR POSITIVE FEED DRILLS AND METHODS FOR DRILLING

(71) Applicant: The Boeing Company, Arlington, VA (US)

(72) Inventor: Clinton J. Moen, Snohomish, WA (US)

(73) Assignee: The Boeing Company, Arlington, VA (US)

(21) Appl. No.: 18/322,724

(22) Filed: May 24, 2023

(51) Int. Cl. B23B 49/02

(52) U.S. Cl. CPC B23B 49/023; B23B 2231/20

(57) ABSTRACT

An offset collet lock includes an actuator, a bracket, a sleeve, and a concentric collet. The bracket is coupled to the actuator and is linearly movable along an actuation axis by the actuator. The sleeve is coupled to the bracket and is linearly movable along a drill axis by the bracket. The drill axis is perpendicular to the actuation axis. The concentric collet is coupled to the sleeve. Linear movement of the sleeve along the drill axis expands or contracts the concentric collet.

### FIELD

The present disclosure relates generally to drilling operations and, more particularly, to an offset collet lock for positive feed drilling equipment.

### BACKGROUND

Many manufacturing operations require precisely positioned holes to the drilled in a workpiece. The holes must be accurately aligned with only relatively small positioning errors. In these operations, a drill jig is typically used to establish hole locations and normality relative to the workpiece surface. In some operations, the drill jig also supports the weight of the drill and reacts to drilling thrust. In these operations, the drill typically includes a nosepiece for attachment of the drill to the drill jig. Conventional nosepieces typically include a collet or a quarter turn clamp that attaches to the drill jig. However, these types of clamping mechanisms are relatively large, which prevents positioning the drill and, thus, locating and drilling holes, adjacent to ancillary structures. Accordingly, those skilled in the art continue with research and development efforts in the field of drilling equipment and operations.

### SUMMARY

Disclosed are examples of an offset collet lock for a positive feed drill, a drilling system, and a drilling method. The following is a non-exhaustive list of examples, which may or may not be claimed, of the subject matter according to the present disclosure.

In an example, the disclosed offset collet lock includes an actuator, a bracket, a sleeve, and a concentric collet. The bracket is coupled to the actuator and is linearly movable along an actuation axis by the actuator. The sleeve is coupled to the bracket and is linearly movable along a drill axis by the bracket. The drill axis is perpendicular to the actuation axis. The concentric collet is coupled to the sleeve. Linear movement of the sleeve along the drill axis expands or contracts the concentric collet.

In an example, the disclosed system includes a positive feed drill and an offset collet lock. The positive feed drill includes a motor, a spindle, and a tool holder. The spindle is coupled to the motor and is rotatable about a drive axis by the motor. The tool holder is coupled to the spindle and is rotatable about a drill axis and is linearly moveable along the drill axis by the spindle. The drill axis is spaced apart from the drive axis and is parallel to the drive axis. The offset collet lock is coupled to the positive feed drill. The offset collet lock includes an actuator, a bracket, a sleeve, and a concentric collet. The bracket is coupled to the actuator and is linearly movable along an actuation axis by the actuator. The actuation axis is perpendicular to the drill axis. The sleeve is coupled to the bracket and is linearly movable along the drill axis by the bracket. The concentric collet is coupled to the sleeve. Linear movement of the sleeve along the drill axis expands or contracts the concentric collet.

In an example, the disclosed method includes steps of: (1) inserting a concentric collet of an offset collet lock of a positive feed drill in an aperture of a drill jig; (2) linearly moving a bracket of the offset collet lock in a first actuation direction along an actuation axis; (3) linearly moving a sleeve of the offset collet lock in a first drill direction along a drill axis, which is perpendicular to the actuation axis, in response to linearly moving the bracket; and (4) expanding the concentric collet to engage the aperture in response to linearly moving the sleeve.

Other examples of the offset collet lock, the system, and the method disclosed herein will become apparent from the following detailed description, the accompanying drawings, and the appended claims.

### BRIEF DESCRIPTION OF THE DRAWINGS

FIG. 1 is a schematic illustration of an example of a positive feed drill;

FIG. 2 is a schematic illustration of an example of operational components of the positive feed drill;

FIG. 3 is a schematic illustration of an example of an offset collet lock for the positive feed drill in an unlocked state;

FIG. 4 is a schematic illustration of an example of the offset collet lock for the positive feed drill in a locked state; and

FIG. 5 is a schematic illustration of a portion of a drilling system;

FIG. 6 is a schematic block diagram of an example of a manufacturing environment;

FIG. 7 is a flow diagram of an example of a method form drilling;

FIG. 8 is a flow diagram of an example of an aircraft manufacturing and service method; and

FIG. 9 is a schematic block diagram of an example of an aircraft.

### DETAILED DESCRIPTION

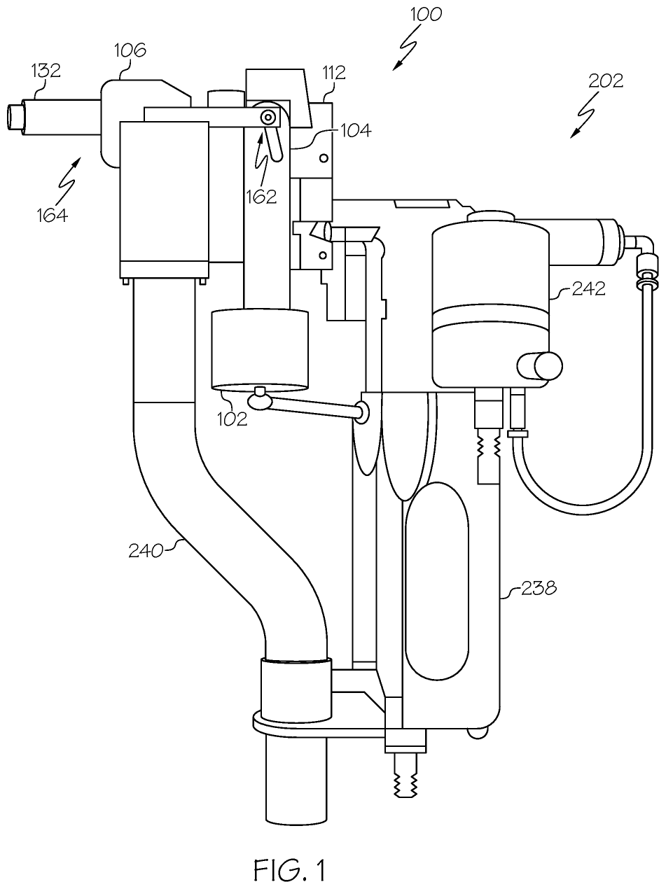

Referring to FIGS. 1-7, by way of examples, the present disclosure is directed to an offset collet lock 100 for attaching a drill to a drill jig during a drilling operation. By way of examples, the present disclosure is also directed to a drilling system 200 (also referred to herein as the system 200) and a drilling method 1000 (also referred to herein as the method 1000) for drilling holes in a workpiece that utilize the offset collet lock 100.

The present disclosure recognizes that the assembly of aerospace structures often involves attachment of a drill to a drill jig to ensure proper alignment of a cutting tool of the drill with a desired hole location in a workpiece. The drill jig establishes hole location and normality relative to the workpiece, reacts to drilling thrust, and supports the weight of the drill motor. As such, an operator of the drill does not have to bear the full weight of the drill and the thrust generated during the drilling operation. In many instances, accurately positioned holes must be drilled in relatively hard materials, such as titanium. To drill holes in hard materials, a positive feed drill (also known as a power feed drill) is used, which includes power feed or rack feed drill motors that produce relatively large axial drilling thrusts. Because positive feed drills are generally heavy and produce relatively large drilling thrust, the drill must be firmly attached to the drill jig. To enable the positive feed drill to be securely and easily mounted to the drill jig, various clamping mechanisms have been incorporated into a nosepiece of the positive feed drill, such as collet clamps and twist lock clamps. However, conventional collet clamps are too large for use in areas with limited access, such as areas adjacent to ancillary structures. Twist lock clamps are typically smaller than collet clamps and, in some instances, can be offset from a drive axis of the positive feed drill. However, conventional twist lock clamps are also unsuitable for use in areas with limited access due to the 45-degree rotation required to engage the twist lock with the drill jig. Examples of the offset collet lock 100, the system 200 and the method 1000, which utilize the offset collet lock 100, provide unique solutions to the above-identified problems associated with using positive feed drills in areas with limited access.

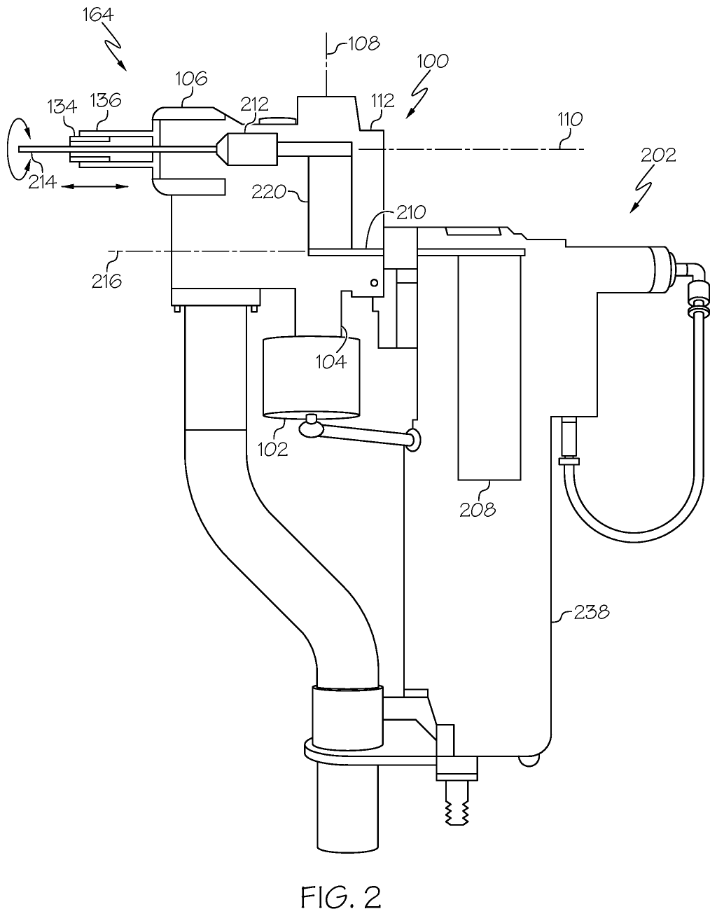

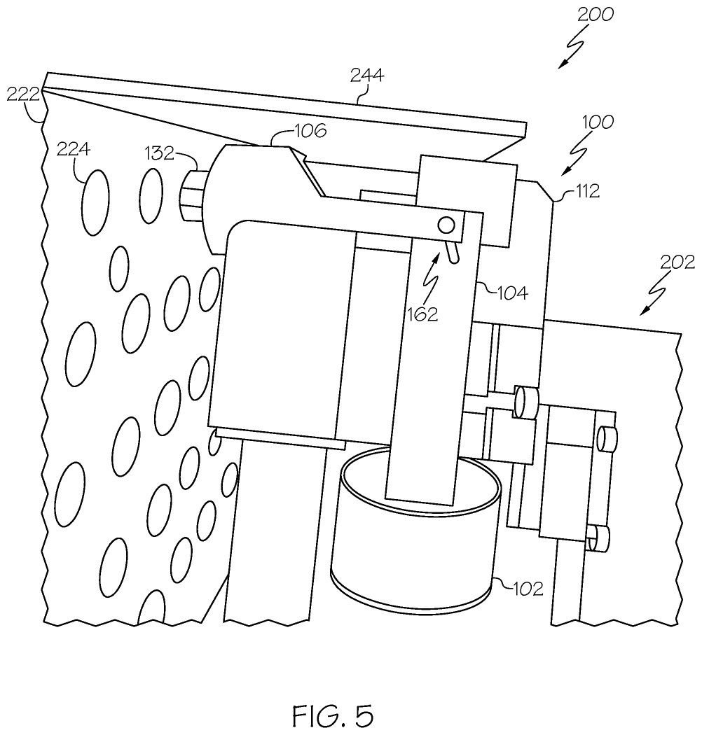

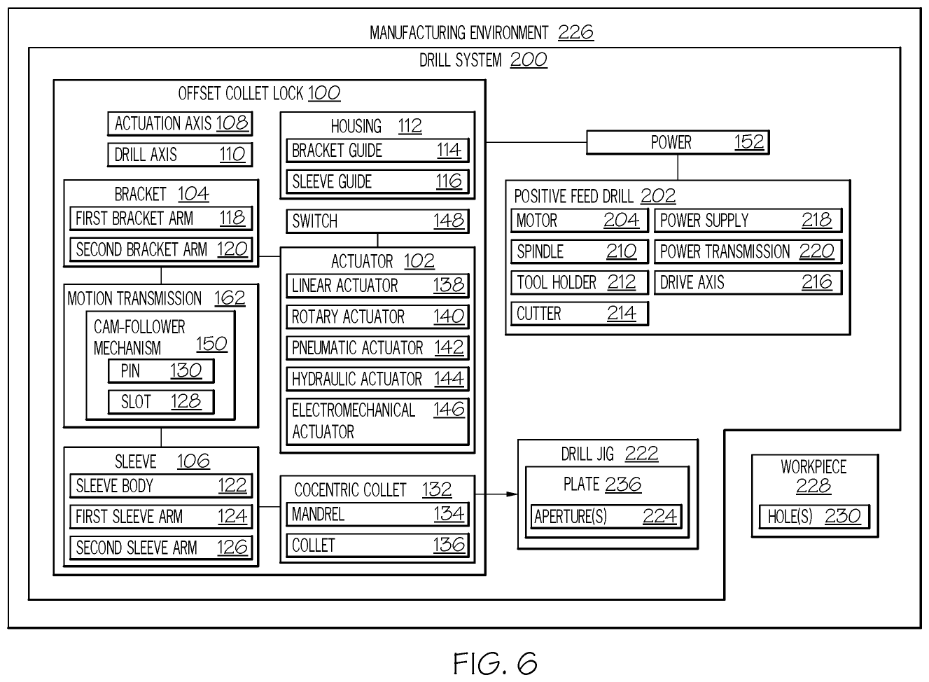

Referring to FIGS. 1 and 2, which schematically illustrate examples of a positive feed drill 202 that includes the offset collet lock 100. The positive feed drill 202 may also be known as a power feed drill. Generally, the positive feed drill 202 simultaneously feeds (e.g., translates) a cutter 214 as it rotates the cutter 214 to drill a hole 230 in a workpiece 228 (FIG. 6). Generally, the offset collet lock 100 forms a nosepiece 164 of the positive feed drill 202 for attachment of the positive feed drill 202 to a drill jig 222 (FIG. 5). In one or more examples, the offset collet lock 100 is mounted, attached, or otherwise coupled to the positive feed drill 202. In one or more examples, the offset collet lock 100 is integrated with the positive feed drill 202.

Referring generally to FIG. 1 and particularly to FIG. 2, in one or more examples, the positive feed drill 202 includes a variety of operational components, including, but not requiring or limited to, one or more of a motor 204, a spindle 210, a power transmission 220, a tool holder 212, and the cutter 214. In one or more examples, the positive feed drill 202 includes or takes the form of a commercially available, off-the-shelf right angle positive feed drill motor. In one or more examples, the positive feed drill 202 includes or takes the form of any type of suitable positive feed drill known to those of ordinary skill.

Referring to FIG. 2, in one or more examples, the motor 204 rotates the spindle 210 about a drive axis 216 and simultaneously rotates the tool holder 212 about a drill axis 110 and translates the tool holder 212 along the drill axis 110. In other words, the motor 204 rotates the spindle 210. Rotation of the spindle 210 rotates the tool holder 212 and, thus, the cutter 214 about the drill axis 110. Rotation of the spindle 210 also linearly moves the tool holder 212 and, thus, the cutter 214 along the drill axis 110. The drill axis 110 is spaced away from (e.g., is offset from) the drive axis 216 and is at least approximately parallel to the drive axis 216. The drive axis 216 may also be referred to as a spindle axis. The drill axis 110 may also be referred to as a cutter axis.

In one or more examples, the spindle 210 is coupled to the power transmission 220. The tool holder 212 is also coupled to the power transmission 220. The power transmission 220 converts and/or transmits rotational motion of the spindle 210 about the drive axis 216 to rotational motion of the tool holder 212 about the drill axis 110 and linear motion of the tool holder 212 along the drill axis 110. The power transmission 220 includes or takes the form of any suitable type of transmission, such as a number of gears, a gearbox, a rack and pinion, rails and bearings, a drive screw, and the like or combinations thereof.

In one or more examples, the tool holder 212 includes or takes the form of any suitable type of tool holding mechanism, such as a chuck, a collet, or other clamp. The cutter 214 includes or takes the form of any suitable rotary cutting tool, such as a drill bit or other cutting bit. The spindle 210 is coupled to the motor 208. The motor 208 is configured such that the spindle 210 and the tool holder 212 (and the cutter 214) are actuated by energizing the motor 208. The motor 208 includes or takes the form of any suitable type of drill motor. As examples, the motor 208 includes or takes the form of a pneumatic motor, a hydraulic motor, or an electromechanical motor. The motor 208 is energized by receiving power (e.g., pneumatic power, hydraulic power, or electric power) from an appropriate power supply (e.g., power supply 218 shown in FIG. 6).

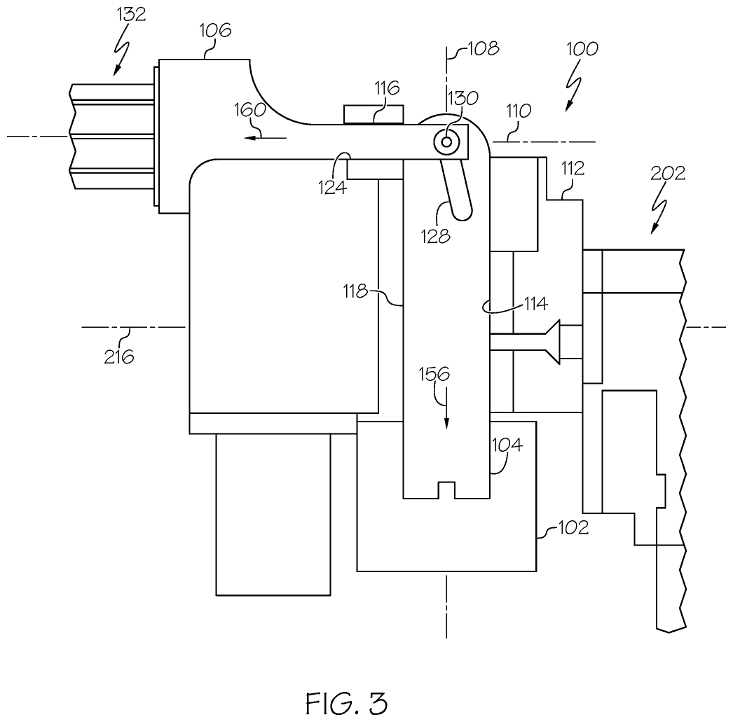

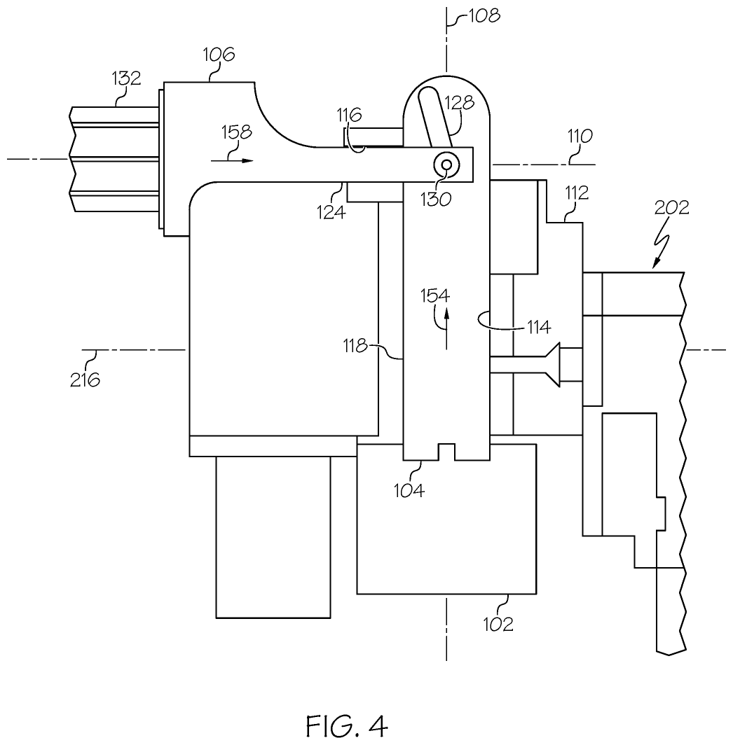

Referring now to FIGS. 3 and 4, which schematically illustrate examples of the offset collet lock 100. FIG. 3 illustrates the offset collet lock 100 in an unlocked state, condition, or configuration. FIG. 4 illustrates the offset collet lock 100 in a locked state, condition, or configuration. In one or more examples, the offset collet lock 100 includes a variety of operational components, including, but not requiring or limited to, one or more of an actuator 102, a bracket 104, a sleeve 106, a concentric collet 132, and a housing 112. The bracket 104 is coupled to the actuator 102. The bracket 104 is linearly movable (e.g., translates) along an actuation axis 108 between the unlocked state (FIG. 3) and the locked state (FIG. 4). The actuator 102 is configured such that the bracket 104 is actuated by energizing the actuator 102. The sleeve 106 is coupled to the bracket 104. The sleeve 106 is linearly movable (e.g., translates) along the drill axis 110 between the unlocked state and the locked state. The drill axis 110 is perpendicular to the actuation axis 108. The bracket 104 is configured such that the sleeve 106 is actuated by actuating the bracket 104. The concentric collet 132 is coupled to the sleeve 106. The concentric collet 132 radially expands (e.g., moves to a radially expanded state) relative to the drill axis 110 in the locked state and radially contracts (e.g., moves to a radially contracted state) relative to the drill axis 110 in the unlocked state. The sleeve 106 is configured such that the concentric collet 132 is actuated by actuating the sleeve 106. In other words, energizing the actuator 102 translates the bracket 104 along the actuation axis 108. Linear movement of the bracket 104 along the actuation axis 108 translates the sleeve 106 along the drill axis 110. Linear movement of the sleeve 106 along the drill axis 110 expands or contracts the concentric collet 132 about the drill axis 110.

In one or more examples, the housing 112 is couplable to the positive feed drill 202. The housing 112 is configured to enclose one or more components of the positive feed drill 202, such as at least a portion of the spindle 210, the tool holder 212, and the power transmission 220. Additionally, the housing 112 is configured to support and/or retain the actuator 102, the bracket 104, the sleeve 106, and/or the concentric collet 132. Although any means of attaching the offset collet lock 100 to the positive feed drill 202 can be utilized, in one or more examples, a rear portion of the housing 112 of the offset collet lock 100 is connected to a motor housing 238 of the positive feed drill 202, such as by complementary threaded fittings. In one or more examples, the bracket 104 is coupled to the housing 112 such that the bracket 104 can translate along the actuation axis 108 relative to the housing 112 in response to actuation by the actuator 102. In the sleeve 106 is coupled to the housing 112 such that the sleeve 106 translates relative to the housing 112 in response to actuation by the bracket 104.

In one or more examples, the bracket 104 is coupled to the actuator 102. The actuator 102 is configured such that the bracket 104 translates along the actuation axis 108 relative to the housing 112 by energizing the actuator 102. The actuator 102 includes or takes the form of any suitable type of linear or rotary actuator. As examples, the actuator 102 includes or takes the form of a pneumatic actuator, a hydraulic actuator, or an electromechanical actuator. The actuator 102 is energized by receiving power 152 (e.g., pneumatic power, hydraulic power, or electric power) from an appropriate power supply, such as the power supply 218 of the positive feed drill 202 (FIG. 6). However, in other examples, the actuator 102 can receive power 152 from a dedicated power supply.

In one or more examples, the sleeve 106 is coupled to the bracket 104. The bracket 104 is configured such that the sleeve 106 translates along the drill axis 110 relative to the housing 112 by translating the bracket 104. In one or more examples, the offset collet lock 100 includes a motion transmission 162 that is configured to convert and/or transmit linear motion of the bracket 104 along the actuation axis 108 to linear motion of the sleeve 106 along the drill axis 110. In one or more examples, the bracket 104 and the sleeve 106 are coupled to the motion transmission 162. In one or more examples, the bracket 104 and the sleeve 106 are coupled to each other via (e.g., through or using) the motion transmission 162. The motion transmission 162 includes any suitable type of transmission mechanism.

In one or more examples, the motion transmission 162 includes or takes the form of a cam-follower mechanism 150. Generally, the cam-follower mechanism 150 includes a cam follower and an associated cam surface or cam track along which the cam follower travels. A first component of the cam-follower mechanism 150 (e.g., the cam follower) is formed by, coupled to, or otherwise associated with one of the bracket 104 or the sleeve 106. A second component of the cam-follower mechanism 150 (e.g., the cam surface or cam track) is formed by, coupled to, or otherwise associated with another one of the bracket 104 or the sleeve 106.

As illustrated in FIGS. 3 and 4, in one or more examples, the cam-follower mechanism 150 includes a pin 130 (e.g., the cam follower) and a slot 128 (e.g., the cam track). In these examples, the pin 130 is coupled to or extends from one of the bracket 104 or the sleeve 106. The slot 128 is formed in another one of the bracket 104 or the sleeve 106. A portion of the pin 130 is received by and travels along or within the slot 128. The slot 128 is configured such that the pin 130 travels within the slot 128 in response to linear movement of the bracket 104 along the actuation axis 108 and results in linear movement of the sleeve 106 along the drill axis 110.

Referring still to FIGS. 3 and 4, in one or more examples, the bracket 104 includes a first bracket arm 118. The first bracket arm 118 is coupled to the actuator 102. For example, the first bracket arm 118 includes a first end and a second end that is opposed to the first end along the actuation axis 108. The first end of the first bracket arm 118 is coupled to the actuator 102. Actuation of the actuator 102 translates the first bracket arm 118 along the actuation axis 108. The sleeve 106 includes a sleeve body 122. The sleeve body 122 is coupled to the concentric collet 132 such that linear movement of the sleeve body 122 along the drill axis 110 expands or contracts the concentric collet 132. In one or more examples, the sleeve body 122 is cylindrical and is concentrically situated about a portion of the concentric collet 132. The sleeve 106 includes a first sleeve arm 124. The first sleeve arm 124 extends from the sleeve body 122, for example, along or at least approximately parallel to the drill axis 110. For example, the first sleeve arm 124 includes a first end coupled to the sleeve body 122 and a second end that is opposed to the first end along the drill axis 110. The first sleeve arm 124 is coupled to the first bracket arm 118, for example, by the motion transmission 162, such as the cam-follower mechanism 150. As an example, the slot 128 (e.g., a first slot or first instance of the slot 128) is formed in the first bracket arm 118, such as proximate the second end thereof. The pin 130 (e.g., a first pin or first instance of the pin 130) is coupled to or otherwise extends from the first sleeve arm 124, such as proximate the second end thereof. In one or more examples, the slot 128 is oriented at an oblique angle relative to the actuation axis 108 such that movement of the pin 130 within the slot 128 translates the sleeve 106 along the drill axis 110.

In one or more examples, the bracket 104 includes a second bracket arm 120. The second bracket arm 120 is also coupled to the actuator 102. For example, the second bracket arm 120 includes a first end and a second end that is opposed to the first end along the actuation axis 108. The first end of the first bracket arm 118 and the first end of the second bracket arm 120 are coupled together or connected by a bracket connector. The bracket connector is coupled to the actuator 102. In these examples, the first bracket arm 118 and the second bracket arm 120 are spaced apart from each other and are at least approximately aligned (e.g., parallel) with each other on opposite sides of the housing 112. In one or more examples, the sleeve 106 includes a second sleeve arm 126. The second sleeve arm 126 extends from the sleeve body 122, for example along or at least approximately parallel to the drill axis 110. For example, the second sleeve arm 126 includes a first end coupled to the sleeve body 122 and a second end that is opposed to the first end along the drill axis 110. The second sleeve arm 126 is coupled to the second bracket arm 120, for example, by the motion transmission 162, such as the cam-follower mechanism 150. As an example, the slot 128 (e.g., a second slot or second instance of the slot 128) is formed in the second bracket arm 120, such as proximate the second end thereof. The pin 130 (e.g., a second pin or second instance of the pin 130) is coupled to or otherwise extends from the second sleeve arm 126, such as proximate the second end thereof.

As illustrated in FIGS. 3 and 4, in one or more examples, with the offset collet lock 100 in the unlocked state (FIG. 3), the bracket 104 is in a rearward or retracted position, the sleeve 106 is in a forward or extended position, and the pin 130 is situated proximate (e.g., at or near) a forward end of the slot 128. A first actuation of the actuator 102 drives the bracket 104 forward (e.g., in a first actuation direction 154) and drives the sleeve 106 rearward (e.g., in a first drill direction 158) to expand the concentric collet 132 and, thereby transition the offset collet lock 100 from the unlocked state to the locked state (FIG. 4). With the offset collet lock 100 in the locked state, the bracket 104 is in a forward or extended position, the sleeve 106 is in a rearward or retracted position, and the pin 130 is situated proximate (e.g., at or near) a rearward end of the slot 128. A second actuation of the actuator 102 drives the bracket 104 rearward (e.g., in a second actuation direction 156) and drives the sleeve 106 forward (e.g., in a second drill direction 160) to contract the concentric collet 132 and, thereby transition the offset collet lock 100 from the locked state to the unlocked state.

While an example configuration of the motion transmission 162 is illustrated that includes the pin 130 and the slot 128, in other examples, different structural configurations are possible and contemplated. For example, the oblique orientation of the slot 128 can be altered (e.g., flipped along the actuation axis 108) such that the relative (e.g., forward and rearward) directions of motion of the bracket 104 and the sleeve 106, described in the above example, are reversed.

In one or more examples, the housing 112 includes a bracket guide 114. The bracket guide 114 is configured to guide linear movement of the bracket 104 along the actuation axis 108. The bracket guide 114 can include any suitable structure that is configured to direct linear motion of the bracket 104 along the actuation axis 108. In one or more examples, the bracket guide 114 includes a first recess formed in a first side of the housing 112 that is suitably sized and shaped to receive the first bracket arm 118 and a second recess formed in a second side of the housing 112 that is suitably sized and shaped to receive the second bracket arm 120 (e.g., when present).

In one or more examples, the housing 112 includes a sleeve guide 116. The sleeve guide 116 is configured to guide linear movement of the sleeve 106 along the drill axis 110. The sleeve guide 116 is configured to guide linear movement of the sleeve 106 along the drill axis 110. The sleeve guide 116 can include any suitable structure that is configured to direct linear motion of the sleeve 106 along the drill axis 110. In one or more examples, the sleeve guide 116 includes a first recess formed in a first side of the housing 112 that is suitably sized and shaped to receive the first bracket arm 118 and a second recess formed in a second side of the housing 112 that is suitably sized and shaped to receive the second bracket arm 120 (e.g., when present).

Referring to FIGS. 2-4, in one or more examples, the concentric collet 132 has an annular or cylindrical shape and is concentric to the drill axis 110. The sleeve 106 has an annular or cylindrical shape and is concentric to the drill axis 110 and to the concentric collet 132. As illustrated in FIG. 2, the tool holder 212 and, this, the cutter 214 rotate about and translate along the drill axis 110. As such, the sleeve 106 and the concentric collet 132 are concentric to the cutter 214 and, during the drilling operation, at least a portion of the cutter 214 extends through the sleeve 106 and the concentric collet 132.

In one or more examples, the concentric collet 132 includes a mandrel 134 and a collet 136. The collet 136 is coupled to the sleeve 106. The collet 136 is concentric to the mandrel 134. The collet 136 linearly moves (e.g., translates) relative to the mandrel 134 to expand or retract in response to linear movement of the sleeve 106 along the drill axis 110.

In one or more examples, the mandrel 134 has an annular or cylindrical shape and forms a substantially cylindrical bore through with the cutter 214 can extend during the drilling operation. The collet 136 has an annular or cylindrical shape, forms a substantially cylindrical bore that receives the mandrel 134, and is concentrically situated about (e.g., around) at least a portion of the mandrel 134. In one or more examples, the collet 136 includes a first end and a second end that is opposite the first end along the drill axis 110. The first end of the collet 136 is segmented, such as to include or form a plurality of fingers or flanges that can flex radially outward. The mandrel 134 includes a first (e.g., cylindrical) portion having first external diameter and a second (e.g., tapered) portion having a second external diameter that is greater than the first external diameter.

In one or more examples, in the unlocked and contracted state, the flanges of the collet 136 overlie the cylindrical portion of the mandrel 134. The flanges extend along the surface of the cylindrical portion of the mandrel 134. Thus, the mandrel 134 and the collet 136 can be inserted through the aperture 224 defined in the drill plate 236 since the aperture 224 has a slightly larger diameter than the unexpanded flanges of the collet 136. In the locked and expanded state, the flanges of the collet 136 overlie the tapered portion of the mandrel 134 and are correspondingly radially expanded. The radially expanded flanges of the drill plate 236. The positive feed drill 202 is thus securely clamped to the drill plate 236.

In one or more examples, the collet 136 is coupled to the sleeve 106. Linear movement of the sleeve 106 in a first (e.g., locking) direction linearly moves the collet 136 along the drill axis 110 relative to the mandrel 134, which is fixed, to position the flanges of the collet 136 along the tapered portion of the mandrel 134 and, thereby, to expand the concentric collet 132 within the aperture 224 and lock the offset collet lock 100 to the drill plate 236. Linear movement of the sleeve 106 in a second (e.g., unlocking) direction, that is opposite the first direction, linearly moves the collet 136 along the drill axis 110 relative to the mandrel 134 to position the flanges of the collet 136 along the cylindrical portion of the mandrel 134 and, thereby, to contract the concentric collet 132 within the aperture 224 and unlock the offset collet lock 100 from the drill plate 236.

In one or more alternative examples, the mandrel 134 is coupled to the sleeve 106. Linear movement of the sleeve 106 in a first (e.g., locking) direction linearly moves the mandrel 134 along the drill axis 110 relative to the collet 136, which is fixed, to position the flanges of the collet 136 along the tapered portion of the mandrel 134 and, thereby, to expand the concentric collet 132 within the aperture 224 and lock the offset collet lock 100 to the drill plate 236. Linear movement of the sleeve 106 in a second (e.g., unlocking) direction, that is opposite the first direction, linearly moves the mandrel 134 along the drill axis 110 relative to the collet 136 to position the flanges of the collet 136 along the cylindrical portion of the mandrel 134 and, thereby, to contract the concentric collet 132 within the aperture 224 and unlock the offset collet lock 100 from the drill plate 236.

Referring to FIG. 1, in one or more examples, the positive feed drill 202 includes other components typically found in power drills and conventional positive feed drill motors. In one or more examples, the positive feed drill 202 includes a vacuum tube 240 that is configured to be coupled to a vacuum source and deliver vacuum suction to collect chips, swarf, and debris generated during the drilling operation. In one or more examples, the positive feed drill 202 includes an oil reservoir 242 that stores oil or other suitable lubricant that is delivered to the motor 208.

Referring now to FIG. 5, which schematically illustrates an example of the drilling system 200. In one or more examples, the drilling system 200 includes a variety of operational components, including, but not requiring or limited to, one or more of the positive feed drill 202, the offset collet lock 100, and the drill jig 222.

In one or more examples, the offset collet lock 100 is adapted to be inserted through and clamped about an aperture 224 defined in a drill plate 236 of the drill jig 222 so as to securely clamp the positive feed drill 202 to the drill plate 236. The drill plate 236 is positioned and secured (e.g., fixed) relative to the workpiece 228 (FIG. 6). Once at least a portion of the concentric collet 132 is inserted in the aperture 224, actuation of the actuator 102 causes the concentric collet 132 to expand and engage the aperture 224, thereby securing the positive feed drill 202 to the drill plate 236. Once the positive feed drill 202 has been secured (e.g., clamped) to the drill plate 236 using the offset collet lock 100, a hole can be drilled in the workpiece 228 underlying the drill plate 236. Because the drill plate 236 can be precisely aligned upon the workpiece 228, the resulting hole in the workpiece 228 is also precisely positioned. Because of relatively small footprint and low profile of the offset collet lock 100 and the offset and parallel arrangement of the drive axis 216 and the drill axis 110 facilitated by the bracket 104 and the sleeve 106, the positive feed drill 202 can be used in areas of limited access, such as proximate (e.g., at or near) or adjacent to an ancillary structure 244.

Referring generally to FIGS. 1-5 and particularly to FIG. 6, which schematically illustrates an example of a manufacturing environment 226 in which the system 200 utilizes the offset collet lock 100 to machine the workpiece 228, such as to drill one or more of the holes 230 in the workpiece 228. The following are examples of the offset collet lock 100, according to the present disclosure. Not all of the elements, features, and/or components described in one example are required in that example. Some of the elements, features, and/or components described in one example may be combined with other examples in various ways without the need to include other features described in those other examples, even though such combination or combinations are not explicitly described by example herein.

In one or more examples, the offset collet lock 100 for the positive feed drill 202 includes the actuator 102, the bracket 104, the sleeve 106, and the concentric collet 132. The bracket 104 is coupled to the actuator 102. The bracket 104 is linearly movable along the actuation axis 108 by the actuator 102. The sleeve 106 is coupled to the bracket 104. The sleeve 106 is linearly movable along the drill axis 110 by the bracket 104. The drill axis 110 is at least approximately perpendicular to the actuation axis 108. The concentric collet 132 is coupled to the sleeve 106. Linear movement of the sleeve 106 along the drill axis 110 expands or contracts the concentric collet 132.

In one or more examples, the offset collet lock 100 includes the housing 112. The housing 112 is couplable to the positive feed drill 202. The housing 112 encloses the spindle 210 and the tool holder 212. The spindle 210 rotates about the drive axis 216 of the positive feed drill 202. The drive axis 216 is at least approximately parallel to the drill axis 110. The tool holder 212 is coupled to the spindle 210. The tool holder 212 rotates about the drill axis 110.

In one or more examples, the bracket 104 moves relative to the housing 112. The housing 112 includes the bracket guide 114. The bracket guide 114 guides linear movement of the bracket 104 along the actuation axis 108.

In one or more examples, the sleeve 106 moves relative to the housing 112. The housing 112 includes a sleeve guide 116. The sleeve guide 116 guides linear movement of the sleeve 106 along the drill axis 110.

In one or more examples, the offset collet lock 100 includes the cam-follower mechanism 150. The cam-follower mechanism 150 is an example of the motion transmission 162. The cam-follower mechanism 150 transfers linear movement of the bracket 104 to linear movement of the sleeve 106.

In one or more examples, the bracket 104 includes the first bracket arm 118. The bracket 104 includes the second bracket arm 120. The sleeve 106 includes the sleeve body 122. The sleeve body 122 is cylindrical. The sleeve 106 includes the first sleeve arm 124. The first sleeve arm 124 extends from the sleeve body 122. The first sleeve arm 124 is coupled to the first bracket arm 118. The sleeve 106 includes the second sleeve arm 126. The second sleeve arm 126 extends from the sleeve body 122. The second sleeve arm 126 is coupled to the second bracket arm 120.

In one or more examples, the first sleeve arm 124 and the first bracket arm 118 are coupled together by the motion transmission 162, such as the cam-follower mechanism 150. Similarly, the second sleeve arm 126 and the second bracket arm 120 are coupled together by the motion transmission 162, such as the cam-follower mechanism 150.

In one or more examples, each one of the first bracket arm 118 and the second bracket arm 120 includes the slot 128. The slot 128 is oriented at an oblique angle relative to the actuation axis 108. Each one of the first sleeve arm 124 and the second sleeve arm 126 includes the pin 130. The pin 130 is located in (e.g., is received by) and moves along (e.g., moves within) the slot 128.

In one or more examples, the concentric collet 132 includes the mandrel 134 and the collet 136. The collet 136 is concentric to the mandrel 134. The collet 136 is coupled to the sleeve 106. The collet 136 moves relative to the mandrel 134 to expand or retract in response to linear movement of the sleeve 106 along the drill axis 110.

In one or more examples, the actuator 102 includes or takes the form of a linear actuator 138. In one or more examples, the actuator 102 includes or takes the form of a rotary actuator 140. In one or more examples, the actuator 102 includes or takes the form of a pneumatic actuator 142. In one or more examples, the actuator 102 includes or takes the form of a hydraulic actuator 144. In one or more examples, the actuator 102 includes or takes the form of an electromechanical actuator 146.

In one or more examples, the offset collet lock 100 includes the switch 148. The switch 148 actuates the actuator 102. The switch 148 is in electrical communication with the actuator 102. Actuation of the switch 148 energizes the actuator 102. In one or more examples, the actuator 102 receives power 152 from the power supply 218 of the positive feed drill 202.

Referring still generally to FIGS. 1-5 and particularly to FIG. 6. The following are examples of the system 200, according to the present disclosure. Not all of the elements, features, and/or components described in one example are required in that example. Some of the elements, features, and/or components described in one example may be combined with other examples in various ways without the need to include other features described in those other examples, even though such combination or combinations are not explicitly described by example herein.

In one or more examples, the drilling system 200 includes the positive feed drill 202 and the offset collet lock 100. The positive feed drill 202 includes the motor 208, the spindle 210, and the tool holder 212. The spindle 210 is coupled to the motor 208. The spindle 210 is rotatable about the drive axis 216 by the motor 208. The tool holder 212 is coupled to the spindle 210. The tool holder 212 is rotatable about the drill axis 110 and is linearly moveable along the drill axis 110 by the spindle 210. The drill axis 110 is spaced apart from and is parallel to the drive axis 216. The offset collet lock 100 is coupled to the positive feed drill 202. The offset collet lock 100 includes the actuator 102, the bracket 104, the sleeve 106, and the concentric collet 132. The bracket 104 is coupled to the actuator 102. The bracket 104 is linearly movable along the actuation axis 108 by the actuator 102. The actuation axis 108 is perpendicular to the drill axis 110. The sleeve 106 is coupled to the bracket 104. The sleeve 106 is linearly movable along the drill axis 110 by the bracket 104. The concentric collet 132 is coupled to the sleeve 106. Linear movement of the sleeve 106 along the drill axis 110 expands or contracts the concentric collet 132.

In one or more examples, the positive feed drill 202 includes the power transmission 220. The power transmission 220 converts rotation of the spindle 210 about the drive axis 216 to rotation of the tool holder 212 about the drill axis 110. The power transmission 220 converts rotational of the spindle 210 about the drive axis 216 to linear movement of the tool holder 212 along the drill axis 110.

In one or more examples, the offset collet lock 100 includes the housing 112. The housing 112 encloses the spindle 210, the tool holder 212, and the power transmission 220.

In one or more examples, the bracket 104 moves relative to the housing 112. In one or more examples, the sleeve 106 moves relative to the housing 112.

In one or more examples, the housing 112 includes the bracket guide 114. The bracket guide 114 guides linear movement of the bracket 104 along the actuation axis 108. In one or more examples, the housing 112 includes the sleeve guide 116. The sleeve guide 116 guides linear movement of the sleeve 106 along the drill axis 110.

In one or more examples, the offset collet lock 100 includes the cam-follower mechanism 150. The cam-follower mechanism 150 is an example of the motion transmission 162. The cam-follower mechanism 150 transfers linear movement of the bracket 104 to linear movement of the sleeve 106.

In one or more examples, the concentric collet 132 includes the mandrel 134 and the collet 136. The collet 136 is concentric to the mandrel 134. The collet 136 is coupled to the sleeve 106. The collet 136 moves relative to the mandrel 134 to expand or retract in response to linear movement of the sleeve 106 along the drill axis 110.

In one or more examples, the drilling system 200 includes the drill jig 222. The drill jig 222 includes the aperture 224. The aperture 224 is configured to receive the concentric collet 132. Expansion of the concentric collet 132 engages the collet 136 with the aperture 224. Contraction of the concentric collet 132 disengages the collet 136 from the aperture 224.

In one or more examples, the bracket 104 includes the first bracket arm 118 and the second bracket arm 120. The sleeve 106 includes the sleeve body 122, the first sleeve arm 124 and the second sleeve arm 126. The sleeve body 122 is cylindrical. The first sleeve arm 124 extends from the sleeve body 122 and is coupled to the first bracket arm 118. The second sleeve arm 126 extends from the sleeve body 122 and is coupled to the second bracket arm 120.

In one or more examples, each one of the first bracket arm 118 and the second bracket arm 120 includes the slot 128. The slot 128 is oriented at an oblique angle relative to the actuation axis 108. Each one of the first sleeve arm 124 and the second sleeve arm 126 includes the pin 130. The pin 130 is located in and moves along the slot 128.

In one or more examples, the actuator 102 includes or takes the form of the linear actuator 138. In one or more examples, the actuator 102 includes or takes the form of the rotary actuator 140. In one or more examples, the actuator 102 includes or takes the form of the pneumatic actuator 142. In one or more examples, the actuator 102 includes or takes the form of the hydraulic actuator 144. In one or more examples, the actuator 102 includes or takes the form of the electromechanical actuator 146.

In one or more examples, the drilling system 200 includes the switch 148. The switch 148 actuates the actuator 102. In one or more examples, the drilling system 200, such as the positive feed drill 202, includes the power supply 218. The actuator 102 receives power 152 from the power supply 218.

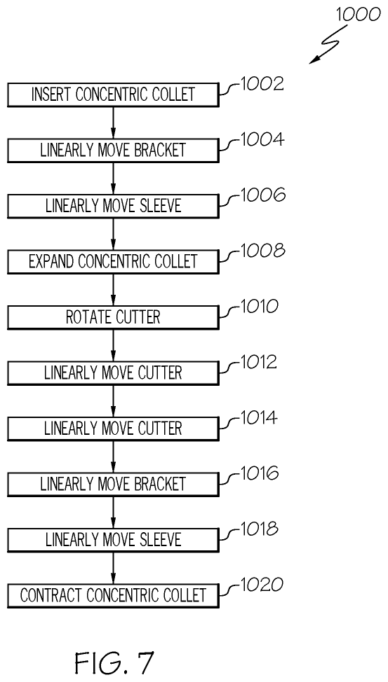

Referring now generally to FIGS. 1-6 and particularly to FIG. 7, which schematically illustrates an example of a method 1000. In one or more examples, the method 1000 is implemented using the offset collet lock 100 and/or the system 200 (FIG. 6). The following are examples of the method 1000, according to the present disclosure. Not all of the elements, steps, and/or operations described in one example are required in that example. Some of the elements, steps, and/or operations described in one example may be combined with other examples in various ways without the need to include other steps described in those other examples, even though such combination or combinations are not explicitly described by example herein.

In one or more examples, the method 1000 includes a step of (block 1002) inserting the concentric collet 132 of the offset collet lock 100 of the positive feed drill 202 in the aperture 224 of the drill jig 222. The method 1000 includes a step of (block 1004) linearly moving the bracket 104 of the offset collet lock 100, for example, forward in the first actuation direction 154, along the actuation axis 108. The method 1000 includes a step of (block 1006) linearly moving the sleeve 106 of the offset collet lock 100, for example, rearward in the first drill direction 158, along the drill axis 110, which is perpendicular to the actuation axis 108, in response to linearly moving the bracket 104. The method 1000 includes a step of (block 1008) expanding the concentric collet 132 to engage the aperture 224 in response to linearly moving the sleeve 106. Performance of the above-described steps (e.g., blocks 1002-1008) achieve or result in securing the positive feed drill 202 to the drill jig 222 using the offset collet lock 100.

In one or more examples, the method 1000 includes a step of (block 1010) rotating the cutter 214 of the positive feed drill 202 about the drill axis 110. The method 1000 includes a step of (block 1012) linearly moving (e.g., extending) the cutter 214, for example, in the second drill direction 160, which is opposite the first drill direction 158, along the drill axis 110 while rotating the cutter 214. The method 1000 includes a step of (block 1014) linearly moving (e.g., retracting) the cutter 214, for example, in the first drill direction 158, along the drill axis 110. Performance of the above-described steps (e.g., block 1010-1014) achieve or result in drilling the hole 230 in the workpiece 228 at a precise location using the positive feed drill 202 and the drill jig 222. The above-described steps (e.g., block 1010-1014) are performed after securing the positive feed drill 202 to the drill jig 222 using the offset collet lock 100.

In one or more examples, the method 1000, such as the steps of (e.g., blocks 1010-1014) rotating and linearly moving the cutter 214, includes a step of energizing the motor 204 of the positive feed drill 202. The method 1000, such as the steps of (e.g., blocks 1010-1014) rotating and linearly moving the cutter 214, includes a step of rotating the spindle 210 of the positive feed drill 202 about the drive axis 216 using the motor 204. The drive axis 216 is spaced apart from the drill axis and is parallel to the drill axis 110. In these examples, rotation and linear movement of the cutter 214 is in response to rotating the spindle 210.

In one or more examples, the method 1000 includes a step of (block 1016) linearly moving the bracket 104 of the offset collet lock 100, for example, rearward in the second actuation direction 156, along the actuation axis 108. The second actuation direction 156 is opposite the first actuation direction 154. The method 1000 includes a step of (block 1018) linearly moving the sleeve 106 of the offset collet lock 100, for example, forward in the second drill direction 160, along the drill axis 110 in response to linearly moving the bracket 104. The second drill direction 160 is opposite the first drill direction 158. The method 1000 includes a step of (block 1020) contracting the concentric collet 132 to disengage the aperture 224 in response to linearly moving the sleeve 106. Performance of the above-described steps (e.g., blocks 1016-1020) achieve or result in releasing the positive feed drill 202 from the drill jig 222 using the offset collet lock 100 for removal of the positive feed drill 202.

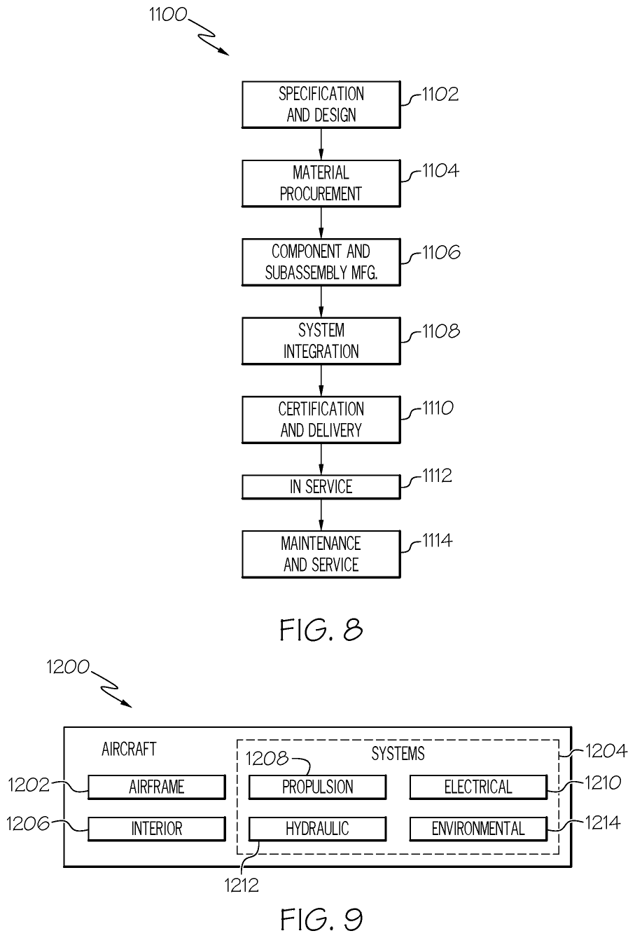

Referring now to FIGS. 8 and 9, examples of the offset collet lock 100, the system 200, and the method 1000 described herein, may be related to, or used in the context of, an aircraft manufacturing and service method 1100, as shown in the flow diagram of FIG. 8 and an aircraft 1200, as schematically illustrated in FIG. 9. As an example, the aircraft 1200 and/or the aircraft production and service method 1100 may include one or more components that include holes drilled using the system 200 and/or according to the method 1000.

Referring to FIG. 9, which illustrates an example of the aircraft 1200. In one or more examples, the aircraft 1200 includes an airframe 1202 having an interior 1206. The aircraft 1200 includes a plurality of onboard systems 1204 (e.g., high-level systems). Examples of the onboard systems 1204 of the aircraft 1200 include propulsion systems 1208. Other examples of the onboard systems 1204 include hydraulic systems 1212, electrical systems 1210, and environmental systems 1214. In other examples, the onboard systems 1204 also includes one or more control systems coupled to an airframe 1202 of the aircraft 1200. In yet other examples, the onboard systems 1204 also include one or more other systems, such as, but not limited to, communications systems, avionics systems, software distribution systems, network communications systems, passenger information/entertainment systems, guidance systems, radar systems, weapons systems, and the like.

Referring to FIG. 8, during pre-production of the aircraft 1200, the manufacturing and service method 1100 includes specification and design of the aircraft 1200 (block 1102) and material procurement (block 1104). During production of the aircraft 1200, component and subassembly manufacturing (block 1106) and system integration (block 1108) of the aircraft 1200 take place. Thereafter, the aircraft 1200 goes through certification and delivery (block 1110) to be placed in service (block 1112). Routine maintenance and service (block 1114) includes modification, reconfiguration, refurbishment, etc. of one or more systems of the aircraft 1200.

Each of the processes of the manufacturing and service method 1100 illustrated in FIG. 8 may be performed or carried out by a system integrator, a third party, and/or an operator (e.g., a customer). For the purposes of this description, a system integrator may include, without limitation, any number of spacecraft manufacturers and major-system subcontractors; a third party may include, without limitation, any number of vendors, subcontractors, and suppliers; and an operator may be an airline, leasing company, military entity, service organization, and so on.

Examples of the offset collet lock 100, the system 200, and the method 1000, shown and described herein, may be employed during any one or more of the stages of the manufacturing and service method 1100 shown in the flow diagram illustrated by FIG. 8. In an example, components machined using the offset collet lock 100 or the system 200 and/or according to the method 1000 may form a portion of component and subassembly manufacturing (block 1106) and/or system integration (block 1108). Further, components machined using the offset collet lock 100 or the system 200 and/or according to the method 1000 may be implemented in a manner similar to components or subassemblies prepared while the aircraft 1200 is in service (block 1112). Also, components machined using the offset collet lock 100 or the system 200 and/or according to the method 1000 may be utilized during system integration (block 1108) and certification and delivery (block 1110). Similarly, components machined using the offset collet lock 100 or the system 200 and/or according to the method 1000 may be utilized, for example and without limitation, while the aircraft 1200 is in service (block 1112) and during maintenance and service (block 1114).

The preceding detailed description refers to the accompanying drawings, which illustrate specific examples described by the present disclosure. Other examples having different structures and operations do not depart from the scope of the present disclosure. Like reference numerals may refer to the same feature, element, or component in the different drawings. Throughout the present disclosure, any one of a plurality of items may be referred to individually as the item and a plurality of items may be referred to collectively as the items and may be referred to with like reference numerals. Moreover, as used herein, a feature, element, component, or step preceded with the word “a” or “an” should be understood as not excluding a plurality of features, elements, components, or steps, unless such exclusion is explicitly recited.

Illustrative, non-exhaustive examples, which may be, but are not necessarily, claimed, of the subject matter according to the present disclosure are provided above. Reference herein to “example” means that one or more feature, structure, element, component, characteristic, and/or operational step described in connection with the example is included in at least one aspect, embodiment, and/or implementation of the subject matter according to the present disclosure. Thus, the phrases “an example,” “another example,” “one or more examples,” and similar language throughout the present disclosure may, but do not necessarily, refer to the same example. Further, the subject matter characterizing any one example may, but does not necessarily, include the subject matter characterizing any other example. Moreover, the subject matter characterizing any one example may be, but is not necessarily, combined with the subject matter characterizing any other example.

As used herein, a system, apparatus, device, structure, article, element, component, or hardware “configured to” perform a specified function is indeed capable of performing the specified function without any alteration, rather than merely having potential to perform the specified function after further modification. In other words, the system, apparatus, device, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware that enable the system, apparatus, structure, article, element, component, or hardware to perform the specified function without further modification. For purposes of this disclosure, a system, apparatus, device, structure, article, element, component, or hardware described as being “configured to” perform a particular function may additionally or alternatively be described as being “adapted to” and/or as being “operative to” perform that function.

Unless otherwise indicated, the terms “first,” “second,” “third,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, the phrase “at least one of”, when used with a list of items, means different combinations of one or more of the listed items may be used and only one of each item in the list may be needed. For example, “at least one of item A, item B, and item C” may include, without limitation, item A or item A and item B. This example also may include item A, item B. and item C, or item B and item C. In other examples, “at least one of” may be, for example, without limitation, two of item A, one of item B, and ten of item C; four of item B and seven of item C; and other suitable combinations. As used herein, the term “and/or” and the “/” symbol includes any and all combinations of one or more of the associated listed items.

For the purpose of this disclosure, the terms “coupled,” “coupling,” and similar terms refer to two or more elements that are joined, linked, fastened, attached, connected, put in communication, or otherwise associated (e.g., mechanically, electrically, fluidly, optically, electromagnetically) with one another. In various examples, the elements may be associated directly or indirectly. As an example, element A may be directly associated with element B. As another example, element A may be indirectly associated with element B, for example, via another element C. It will be understood that not all associations among the various disclosed elements are necessarily represented. Accordingly, couplings other than those depicted in the figures may also exist.

As used herein, the term “approximately” refers to or represents a condition that is close to, but not exactly, the stated condition that still performs the desired function or achieves the desired result. As an example, the term “approximately” refers to a condition that is within an acceptable predetermined tolerance or accuracy, such as to a condition that is within 10% of the stated condition. However, the term “approximately” does not exclude a condition that is exactly the stated condition. As used herein, the term “substantially” refers to a condition that is essentially the stated condition that performs the desired function or achieves the desired result.

FIGS. 1-6 and 9, referred to above, may represent functional elements, features, or components thereof and do not necessarily imply any particular structure. Accordingly, modifications, additions and/or omissions may be made to the illustrated structure. Additionally, those skilled in the art will appreciate that not all elements, features, and/or components described and illustrated in FIGS. 1-6 and 9, referred to above, need be included in every example and not all elements, features, and/or components described herein are necessarily depicted in each illustrative example. Accordingly, some of the elements, features, and/or components described and illustrated in FIGS. 1-6 and 9 may be combined in various ways without the need to include other features described and illustrated in FIGS. 1-6 and 9, other drawing figures, and/or the accompanying disclosure, even though such combination or combinations are not explicitly illustrated herein. Similarly, additional features not limited to the examples presented, may be combined with some or all of the features shown and described herein. Unless otherwise explicitly stated, the schematic illustrations of the examples depicted in FIGS. 1-6 and 9, referred to above, are not meant to imply structural limitations with respect to the illustrative example. Rather, although one illustrative structure is indicated, it is to be understood that the structure may be modified when appropriate. Accordingly, modifications, additions and/or omissions may be made to the illustrated structure. Furthermore, elements, features, and/or components that serve a similar, or at least substantially similar, purpose are labeled with like numbers in each of FIGS. 1-6 and 9, and such elements, features, and/or components may not be discussed in detail herein with reference to each of FIGS. 1-6 and 9. Similarly, all elements, features, and/or components may not be labeled in each of FIGS. 1-6 and 9, but reference numerals associated therewith may be utilized herein for consistency.

In FIGS. 7 and 8, referred to above, the blocks may represent operations, steps, and/or portions thereof and lines connecting the various blocks do not imply any particular order or dependency of the operations or portions thereof. It will be understood that not all dependencies among the various disclosed operations are necessarily represented. FIGS. 7 and 8 and the accompanying disclosure describing the operations of the disclosed methods set forth herein should not be interpreted as necessarily determining a sequence in which the operations are to be performed. Rather, although one illustrative order is indicated, it is to be understood that the sequence of the operations may be modified when appropriate. Accordingly, modifications, additions and/or omissions may be made to the operations illustrated and certain operations may be performed in a different order or simultaneously. Additionally, those skilled in the art will appreciate that not all operations described need be performed.

Further, references throughout the present specification to features, advantages, or similar language used herein do not imply that all of the features and advantages that may be realized with the examples disclosed herein should be, or are in, any single example. Rather, language referring to the features and advantages is understood to mean that a specific feature, advantage, or characteristic described in connection with an example is included in at least one example. Thus, discussion of features, advantages, and similar language used throughout the present disclosure may, but do not necessarily, refer to the same example.

The described features, advantages, and characteristics of one example may be combined in any suitable manner in one or more other examples. One skilled in the relevant art will recognize that the examples described herein may be practiced without one or more of the specific features or advantages of a particular example. In other instances, additional features and advantages may be recognized in certain examples that may not be present in all examples. Furthermore, although various examples of the offset collet lock 100, the system 100, and the method 1000 have been shown and described, modifications may occur to those skilled in the art upon reading the specification. The present application includes such modifications and is limited only by the scope of the claims.

What is claimed is:

1. An offset collet lock for a positive feed drill, the offset collet lock comprising:
an actuator;
a bracket that is coupled to the actuator and that is linearly movable along an actuation axis by the actuator;
a sleeve that is coupled to the bracket and that is linearly movable along a drill axis, which is perpendicular to the actuation axis, by the bracket; and
a concentric collet that is coupled to the sleeve,
wherein linear movement of the sleeve along the drill axis expands or contracts the concentric collet.

2. The offset collet lock of claim 1, further comprising a housing that is couplable to the positive feed drill,
wherein the housing encloses a spindle that rotates about a drive axis of the positive feed drill, which is parallel to the drill axis, and a tool holder that is coupled to the spindle and that rotates about the drill axis.

3. The offset collet lock of claim 2, wherein:
the bracket moves relative to the housing; and
the housing comprises a bracket guide that guides linear movement of the bracket along the actuation axis.

4. The offset collet lock of claim 2, wherein:
the sleeve moves relative to the housing; and
the housing comprises a sleeve guide that guides linear movement of the sleeve along the drill axis.

5. The offset collet lock of claim 1, further comprising a cam-follower mechanism that transfers linear movement of the bracket to linear movement of the sleeve.

6. The offset collet lock of claim 1, wherein:
the bracket comprises:
a first bracket arm; and
a second bracket arm; and
the sleeve comprises:
a sleeve body that is cylindrical;
a first sleeve arm that extends from the sleeve body and that is coupled to the first bracket arm; and
a second sleeve arm that extends from the sleeve body and that is coupled to the second bracket arm.

7. The offset collet lock of claim 6, wherein:
each one of the first bracket arm and the second bracket arm comprises a slot that is oriented at an oblique angle relative to the actuation axis; and
each one of the first sleeve arm and the second sleeve arm comprises a pin that is located in and moves along the slot.

8. The offset collet lock of claim 1, wherein:
the concentric collet comprises:
a mandrel; and
a collet that is concentric to the mandrel and that is coupled to the sleeve; and
the collet moves relative to the mandrel to expand or retract in response to linear movement of the sleeve along the drill axis.

9. The offset collet lock of claim 1, wherein the actuator comprises one of a linear actuator and a rotary actuator.

10. The offset collet lock of claim 1, wherein the actuator comprises one of a pneumatic actuator, a hydraulic actuator, and an electromechanical actuator.

11. The offset collet lock of claim 1, further comprising a switch that actuates the actuator,
the actuator receives power from a power supply of the positive feed drill.

12. A drilling system comprising:
a positive feed drill that comprises:
a motor;
a spindle that is coupled to the motor and that is rotatable about a drive axis by the motor; and
a tool holder that is coupled to the spindle and that is rotatable about and linearly moveable along a drill axis, which is spaced apart from and parallel to the drive axis, by the spindle; and
an offset collet lock that is coupled to the positive feed drill and that comprises:
an actuator;
a bracket that is coupled to the actuator and that is linearly movable along an actuation axis, which is perpendicular to the drill axis, by the actuator;
a sleeve that is coupled to the bracket and that is linearly movable along the drill axis by the bracket; and
a concentric collet that is coupled to the sleeve,
wherein linear movement of the sleeve along the drill axis expands or contracts the concentric collet.

13. The drilling system of claim 12, wherein the positive feed drill further comprises a power transmission that converts rotation of the spindle about the drive axis to rotation of the tool holder about the drill axis and linear movement of the tool holder along the drill axis.

14. The drilling system of claim 13, wherein the offset collet lock further comprises a housing that encloses the spindle, the tool holder, and the power transmission.

15. The drilling system of claim 14, wherein:
the bracket moves relative to the housing;
the sleeve moves relative to the housing; and
the housing comprises:
a bracket guide that guides linear movement of the bracket along the actuation axis; and
a sleeve guide that guides linear movement of the sleeve along the drill axis.

16. The drilling system of claim 12, wherein the offset collet lock further comprises a cam-follower mechanism that transfers linear movement of the bracket to linear movement of the sleeve.

17. The drilling system of claim 12, wherein:
the concentric collet comprises:
a mandrel; and
a collet that is concentric to the mandrel and that is coupled to the sleeve; and
the collet moves relative to the mandrel to expand or retract in response to linear movement of the sleeve along the drill axis.

18. The drilling system of claim 17, further comprising a drill jig that comprises an aperture, wherein:
the aperture is configured to receive the concentric collet;
expansion of the concentric collet engages the collet with the aperture; and
contraction of the concentric collet disengages the collet from the aperture.

19. A drilling method comprising:
inserting a concentric collet of an offset collet lock of a positive feed drill in an aperture of a drill jig;
linearly moving a bracket of the offset collet lock in a first actuation direction along an actuation axis;
linearly moving a sleeve of the offset collet lock in a first drill direction along a drill axis, which is perpendicular to the actuation axis, in response to linearly moving the bracket; and
expanding the concentric collet to engage the aperture in response to linearly moving the sleeve.

20. The drilling method of claim 19, further comprising:
energizing a motor of the positive feed drill;
rotating a spindle of the positive feed drill about a drive axis, which is spaced apart from and parallel to the drill axis, using the motor;
rotating a cutter of the positive feed drill about the drill axis is in response to rotating the spindle;
linearly moving the cutter in second drill direction, which is opposite the first drill direction, along the drill axis is in response to rotating the spindle;
linearly moving the bracket of the offset collet lock in a second actuation direction, that is opposite the first actuation direction, along the actuation axis;
linearly moving the sleeve of the offset collet lock in the second drill direction along the drill axis in response to linearly moving the bracket; and
contracting the concentric collet to disengage the aperture in response to linearly moving the sleeve.
